(19) United States
(12) Patent Application Publication
(10) Pub. No.: US 2015/0019163 A1
(43) Pub. Date: Jan. 15, 2015

(54) ORIENTATION SENSING COMPUTING DEVICES

(71) Applicant: Bradford Needham, North Plains, OR (US)

(72) Inventor: Bradford Needham, North Plains, OR (US)

(21) Appl. No.: 13/825,971

(22) PCT Filed: Mar. 25, 2012
(86) PCT No.: PCT/US12/30488

§ 371 Date: Sep. 3, 2014

(51) Int. Cl. G01B 11/26; G01C 1/00

(52) U.S. Cl. CPC G01B 11/26; G01C 1/00
USPC 702/151

(57) ABSTRACT

A computing device including orientation sensors is provided herein. The computing device includes a base and a lid pivotally attached to the base. The computing device also includes an orientation sensing system configured to determine an orientation of the base and the lid relative to an environment of the computing device.

### TECHNICAL FIELD

The present invention relates to the use of sensors to determine the orientation of components of computing devices.

### BACKGROUND ART

Orientation sensors such as accelerometers, compasses, and gyroscopes are commonly used in smartphones and other similar computing devices for determining the orientation of such devices. However, computing devices that include a base and a hinged lid, such as laptop computers and flip-style mobile phones, do not have the capability to detect the orientations of the individual members of the devices.

### BRIEF DESCRIPTION OF THE DRAWINGS

FIG. 1 is a block diagram of a computing system that may be used in accordance with embodiments;

FIG. 2 is a perspective view of a computing device in accordance with embodiments;

FIG. 3 is a process flow diagram showing a method for detecting an orientation of a lid and a base of a computing device in accordance with embodiments;

FIG. 4 is a perspective view of another computing device in accordance with embodiments;

FIG. 5 is a process flow diagram showing another method for detecting an orientation of a lid and a base of a computing device in accordance with embodiments;

FIG. 6 is a perspective view of a convertible tablet including both a pivot and a tilt in accordance with embodiments;

FIG. 7 is a perspective view of a convertible tablet including two pivots in accordance with embodiments; and

FIG. 8 is a block diagram showing a tangible, non-transitory computer-readable medium that stores code for detecting the orientation of members of a computing device in accordance with embodiments.

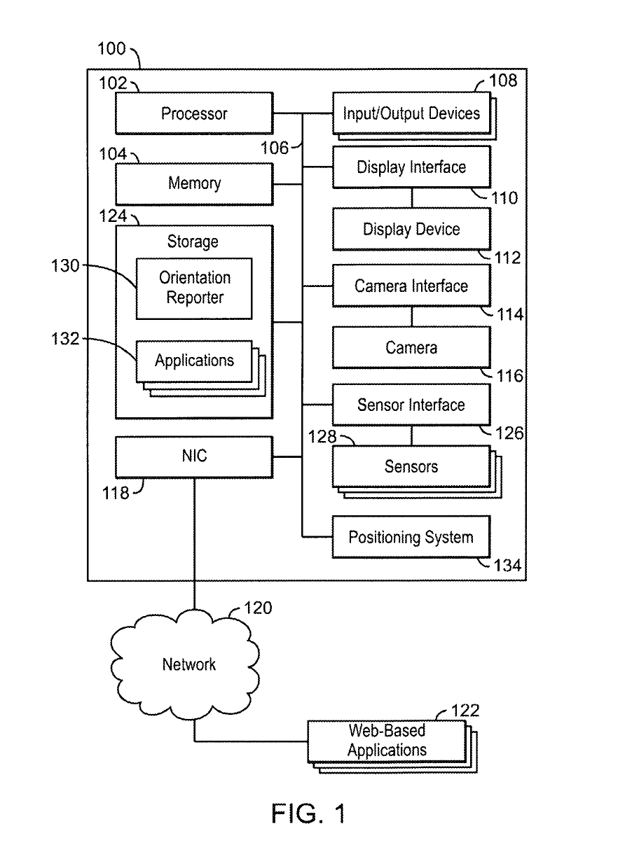

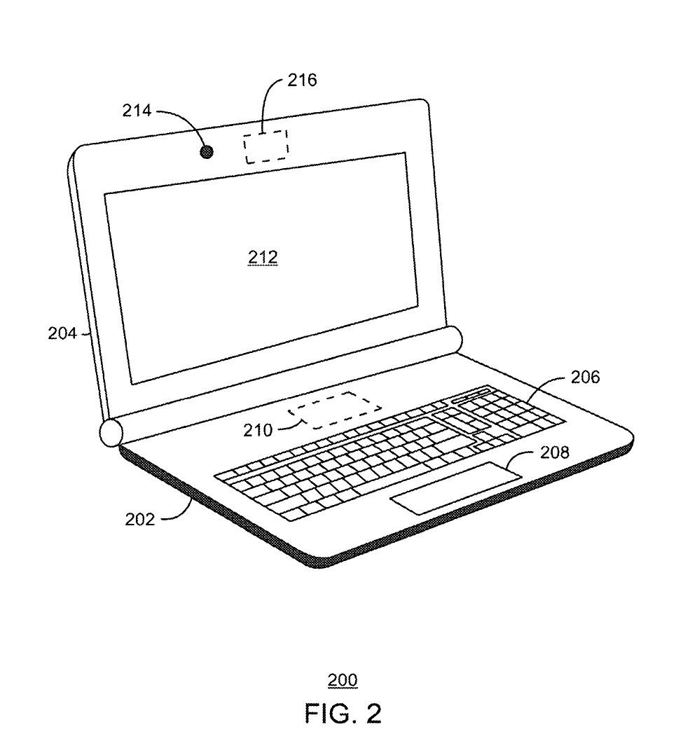

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Many applications may utilize information relating to the orientation of the computing device on which they are operating. As used herein, the term “orientation” is used to refer to an angular bearing of a computing device relative to the environment. For example, the orientation of a computing device may have an azimuthal component and an elevation angle component. Applications may use such orientation information to adapt the manner in which they are functioning. For example, the orientation of the computing device can be used in conjunction with the geographical position of the computing device to identify a feature in the user's environment that the computing device is pointed toward. In the case of an augmented reality application, the orientation of the computing device may correspond with the viewing direction of a camera disposed on the computing device, and the augmented reality application may adapt an image that is being displayed to the user based on the orientation of the computing device. Orientation information can also be used by an application to determine whether the computing device is resting on a level surface or is being held by a user, for example, and the application may adjust its output accordingly. Various additional uses for such orientation information will be recognized in light of the present description.

Traditionally, computing devices are equipped to identify a single orientation. However, many computing devices have members that are capable of being separately oriented in different directions. For example, computing devices such as laptops, convertible tablets, and flip-style phones, among others, include a base and a lid that are capable of pivoting and/or tilting with respect to one another. Embodiments described herein provide for the detection of the individual orientations of two or more members of a computing device.

Further, in various embodiments, applications utilize information relating to an alignment of members, e.g., a lid and a base, of a computing device with respect to each other. As used herein, the term “alignment” is used to refer to the position of one member of a computing device relative to another member of the computing device. Applications may utilize such alignment information to adapt the manner in which they are functioning. For example, a camera of a computing device may adjust its output based on the alignment of the lid of the computing device with respect to the base. In addition, the alignment of the lid of a computing device with respect to the base may be used to determine the orientation of the lid based on the orientation of the base.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing system 100 that may be used in accordance with embodiments. The computing system 100 may be any type of computing device that has members that are capable of being oriented in different directions, such as a mobile phone, a laptop computer, or a convertible tablet, among others. The computing system 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory (RAM), read only memory (ROM), flash memory, or any other suitable memory systems. The instructions that are executed by the processor 102 may be used to implement a method that includes determining two or more orientations corresponding to two or more members of the computing system 100 relative to the environment.

The processor 102 maybe connected through a bus 106 to one or more input/output (I/O) devices 108. The I/O devices 108 may include, for example, a keyboard and a pointing device, wherein the pointing device may include a touchpad or a touchscreen, among others. The I/O devices 108 may be built-in components of the computing system 100, or may be devices that are externally connected to the computing system 100.

The processor 102 may also be linked through the bus 106 to a display interface 110 adapted to connect the system 100 to a display device 112, wherein the display device 112 may include a display screen that is a built-in component of the computing system 100. The display device 112 may also include a computer monitor, television, or projector, among others, that is externally connected to the computing system 100.

A camera interface 114 may be configured to link the processor 102 through the bus 106 to a camera 116. In various embodiments, the camera 116 may be a Webcam or other type of camera that is disposed within the computing system 100.

A network interface controller (NIC) 118 may be adapted to connect the computing system 100 through the bus 106 to a network 120. In various embodiments, the NIC 118 is a wireless NIC. Through the network 120, the computing system 100 may access Web-based applications 122. The computing system 100 may also download the Web-based applications 122 and store the Web-based applications 122 within a storage device 124 of the computing system 100.The storage device 124 can include a hard drive, an optical drive, a thumb drive, an array of drives, or any combinations thereof.

The processor 102 may also be connected through a bus 106 to a sensor interface 126. The sensor interface 126 may be adapted to connect the processor 102 to a plurality of sensors 128, including orientation sensors and/or alignment sensors. The sensors 128 may be built into the computing system 100, or may be connected to the computing system 100 through wired or wireless connections. An orientation sensor may include, for example, a magnetometer, an accelerometer, a gyroscope, and the like. The orientation sensor may be used to collect data relating to the orientation of a member of the computing system 100. In some embodiments, the computing system 100 includes two or more orientation sensors that are configured to detect the individual orientations of two or more members of the computing system 100. Further, an alignment sensor may be used to detect the relative alignment between two members of the computing system 100. The alignment sensor may include, for example, a wheel encoder, a potentiometer, a flex sensor, and the like.

The computing system 100 may also include an orientation reporter 130 that is configured to collect the data from the sensors 128, compute the orientation information relating to the computing system 100 using the data, and report the orientation information to applications 132 that are executing on the computing system 100. In various embodiments, the orientation reporter 130 is an orientation application programming interface (API). The applications 132 may be included within the storage device 124, and may include any number of the Web-based applications 122. In some embodiments, individual applications 132 can be configured to receive the data from the sensors 128 and compute the orientation information for use by the application 132, in which case, the orientation reporter 130 can be eliminated.

In addition, the computing system 100 can include a positioning system 134, which may be used to determine a geographical location of the computing system 100. The positioning system 134 can include a global positioning system (GPS) and a signal triangulation system, among others.

FIG. 2 is a perspective view of a computing device 200 in accordance with embodiments. In various embodiments, the computing device 200 is the computing system 100 described above with respect to FIG. 1. Further, the computing device 200 may be any type of computing device that includes at least two members, such as a base and a hinged lid. For example, the computing device 200 may be a flip-style mobile phone or a laptop computer.

The computing device 200 shown in FIG. 2 includes a base 202, as well as a lid 204 that is pivotally attached to the base 202. The base 202 of the computing device 200 may include a keyboard 206 and a touchpad 208. The base 202 may also include a first orientation sensor 210. The first orientation sensor 210 may include, for example,a magnetometer, an accelerometer, a gyroscope, and the like. In addition, the first orientation sensor 210 may include a variety of different types of sensors. Further, the first orientation sensor 210 may be located anywhere within the base 202 of the computing device 200.

The lid 204 of the computing device 200 may include a display screen 212 and a camera 214, such as a Webcam. The lid 204 may also include a second orientation sensor 216. The second orientation sensor 216 may include, for example, a magnetometer, an accelerometer, a gyroscope, and the like. In addition, the second orientation sensor 216 may include a variety of different types of orientation sensors. Further, the second orientation sensor 216 may be located anywhere within the lid 204 of the computing device 200.

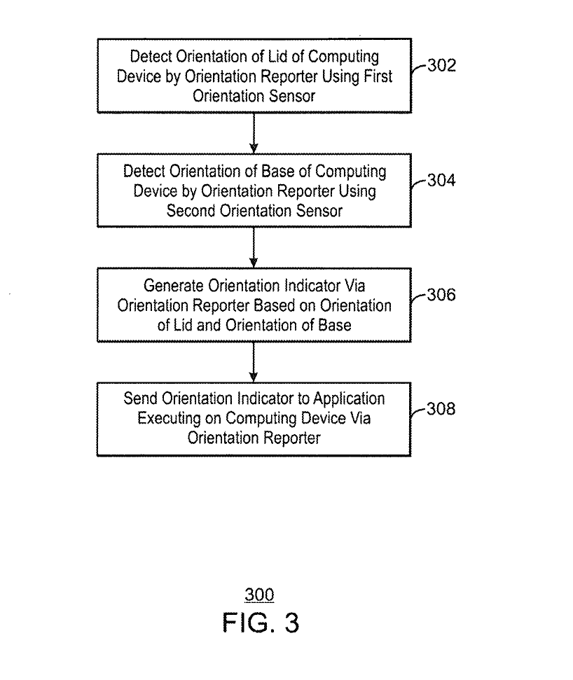

Each of the orientation sensors 210 and 216 separately detect the orientation of the member to which it is coupled. For example, the first orientation sensor 210 may be used to detect the orientation of the base 202 of the computing device 200, while the second orientation sensor 216 may be used to detect the orientation of the lid 204 of the computing device 200. In various embodiments, the first orientation sensor 210 and the second orientation sensor 216 may be used to detect the orientations of the base 202 and the lid 204, respectively, at the same point in time or at different points in time, depending on the specific application. The sensor information may be sent to the orientation reporter 130 for further processing, as described below with reference to FIG. 3.

FIG. 3 is a process flow diagram showing a method 300 for detecting an orientation of a lid and a base of a computing device in accordance with embodiments. The computing device that implements the method 300 may be the computing device 200 discussed with respect to FIG. 2.The method begins at block 302, at which the orientation of the lid of the computing device is detected by the orientation reporter using a first orientation sensor. The orientation of the lid may include an orientation of the lid with respect to the environment of the computing device.

At block 304, an orientation of a base of the computing device is detected by the orientation reporter using a second orientation sensor. The orientation of the base may include an orientation of the base with respect to the environment of the computing device.

At block 306,the orientation reporter generates an orientation indicator based on the orientation of the lid and the orientation of the base. In some embodiments, the orientation indicator is a combined orientation indicator that simultaneously indicates both the orientation of the base and the orientation of the lid. In some embodiments, the orientation indicator indicates a specified orientation, which may be either the orientation of the base only or the orientation of the lid only. Reporting the orientation of the lid only or the base only enables the orientation reporter to provide backward compatibility for applications that may not be configured to properly interpret a combined orientation indicator. The computing device may include a user interface that enables a user to select the type of orientation indicator desired. In embodiments, the user interface is a switch, such as a user-level software switch or a hardware switch, that includes both a lid setting and a base setting. When the switch is on the lid setting, the orientation indicator reports the orientation of the lid. When the switch is on the base setting, the orientation indicator reports the orientation of the base.

At block 308, the orientation reporter sends the orientation indicator to an application executing on the computing device. In some embodiments, the application is an orientation-based application or a context-aware application. The application may utilize the orientation indicator to determine a number of conditions relating to the environment of the computing device. The application may then adapt its behavior, e.g., its output, accordingly. For example, if the application is an augmented reality application, the application may use the orientation of the lid, as specified by the orientation indicator, to determine the orientation of the camera, as well as the objects at which the camera is pointing. This may enable the application to provide the user with a dynamic and interactive augmented reality experience.

As another example, the application may determine the orientation of the computing device relative to a working surface based on the orientation of the base, as specified by the orientation indicator. This may enable the application to determine, for example, whether the base of the computing device is resting on a level surface or is being held by a user. The application may then make a number of determinations based on this information, such as whether the user is likely to stop using the computing device soon. The application may then adjust its output accordingly. For example, if the application determines that the user is likely to stop using the computing device and, thus, the application soon, the application may begin to display more popular or highly-rated information to the user in order to catch the user's attention and to delay the closing of the application.

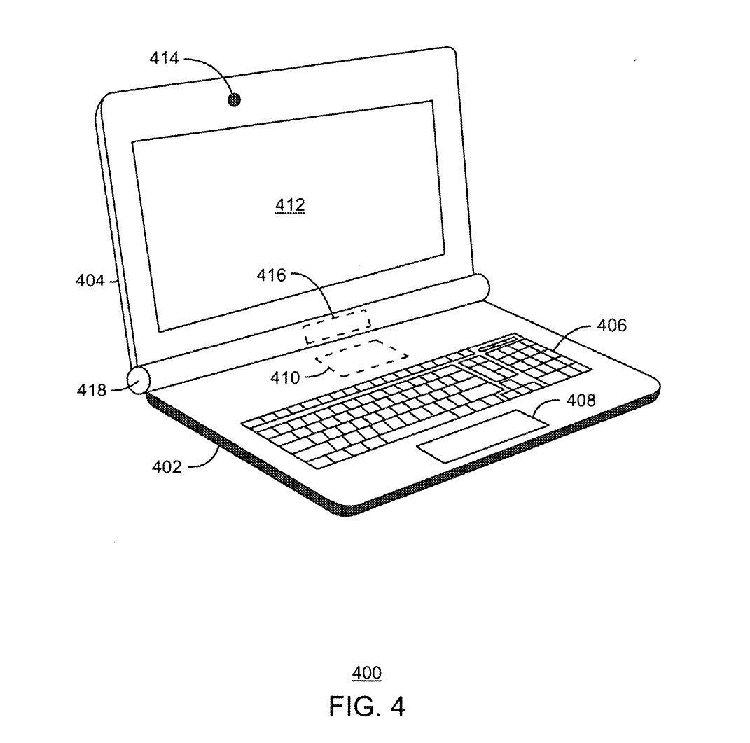

FIG. 4 is a perspective view of another computing device 400in accordance with embodiments. In various embodiments, the computing device 400 is the computing system 100 described above with respect to FIG. 1. Further, the computing device 400 may be any type of computing device that includes at least two members, such as a base and a hinged lid. For example, the computing device 400 may be a flip-style mobile phone or a laptop computer.

Similar to the computing device 200 of FIG. 2, the computing device 400 may include a base 402, as well as a lid 404 that is pivotally attached to the base 402. The base 402 of the computing device 400 may include a keyboard 406 and a touchpad 408, as well as an orientation sensor 410, such as the first orientation sensor 210 discussed above with respect the computing device 200. The lid 404 of the computing device 400 may also include a display screen 412 and a camera 414, as discussed above with respect to the computing device 200.

Further, in the embodiment shown in FIG. 4, the lid 404 of the computing device 400 may include an alignment sensor 416. The alignment sensor 416 may be a lid-rotation sensor that is used to indicate an alignment of the base 402 and the lid 404 relative to each other. The alignment sensor 416 may be located anywhere within the computing device 400. For example, in various embodiments, the alignment sensor 416 is included within a hinge region 418 of the lid 404.

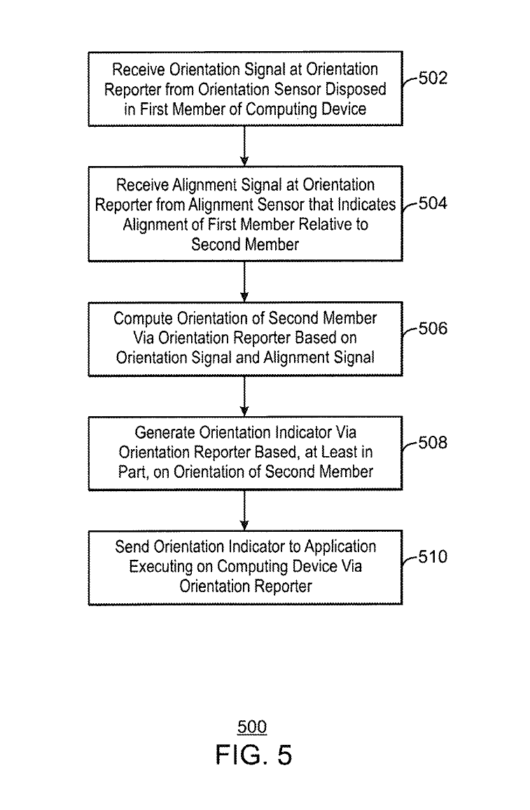

In various embodiments, the orientation sensor 410 is used to detect an orientation of the base 402 of the computing device 400. In addition, the alignment sensor 416 may be used to determine an alignment of the lid 404 relative to the base 402. The orientation of the base 402 and the alignment of the lid 404 relative to the base 402 may then be used to determine the orientation of the lid 404. Further, in some embodiments, the orientation sensor 410 may be located within the lid 404 of the computing device 400, rather than the base 402. In such an embodiment, the orientation of the lid 404 and the alignment of the lid 404 relative to the base 402 may be used to determine the orientation of the base 402. The sensor information may be sent to the orientation reporter 130 for further processing, as described below with reference to FIG. 5.

FIG. 5 is a process flow diagram showing another method 500 for detecting an orientation of a lid and a base of a computing device in accordance with embodiments. For example, the method 500 may be used to detect the orientation of the lid and the base relative to the environment. In various embodiments, the computing device that implements the method 500 is the computing device 400 discussed with respect to FIG. 4. The computing device includes at least a first member and a second member. In various embodiments, the first member is the base of the computing device, and the second member is the lid of the computing device. However, in some embodiments, the first member is the lid, while the second member is the base.

The method begins at block 502, at which an orientation signal is received at an orientation reporter from an orientation sensor disposed in the first member of the computing device. The orientation signal may indicate an orientation of the first member relative to an environment of the first member.

At block 504, an alignment signal is received at the orientation reporter from an alignment sensor that indicates the alignment of the first member relative to the second member. The alignment sensor may be disposed in the second member of the computing device, or may be disposed within a hinge region that connects the first member to the second member. The alignment of the first member relative to the second member may include a rotational angle of the two members with relation to one another.

At block 506, the orientation reporter computes the orientation of the second member based on the orientation signal and the alignment signal. The computed orientation of the second member indicates the orientation of the second member relative to the environment of the second member.

At block 508, the orientation reporter generates an orientation indicator based, at least in part, on the orientation of the second member. In some embodiments, the orientation indicator may be generated based on the orientation of the second member and the orientation of the first member. The orientation indicator may be a combined orientation indicator, or may indicate an orientation of a selected one of the members, as discussed above with respect to FIG. 3.

At block 510, the orientation reporter sends the orientation indicator to an application executing on the computing device. In some embodiments, the application is an orientation-based application or a context-aware application. The application may utilize the orientation indicator to determine a number of conditions relating to the environment of the computing device, and may adapt its behavior accordingly, as discussed above with respect to the method 300 of FIG. 3.

It will be appreciated that any number of additional actions may be included within the method 500, depending on the specific application. For example, the method 500 may be used to detect and report the orientation of any number of additional components of the computing device, such as a mouse, numeric keypad, or keyboard, among others. Such additional components may be communicably coupled to the computing device via a wired or wireless connection. Further, the method 500 may be used to detect and report the orientation of specific objects within the environment of the computing device, e.g., a user's head, with respect to the computing device.

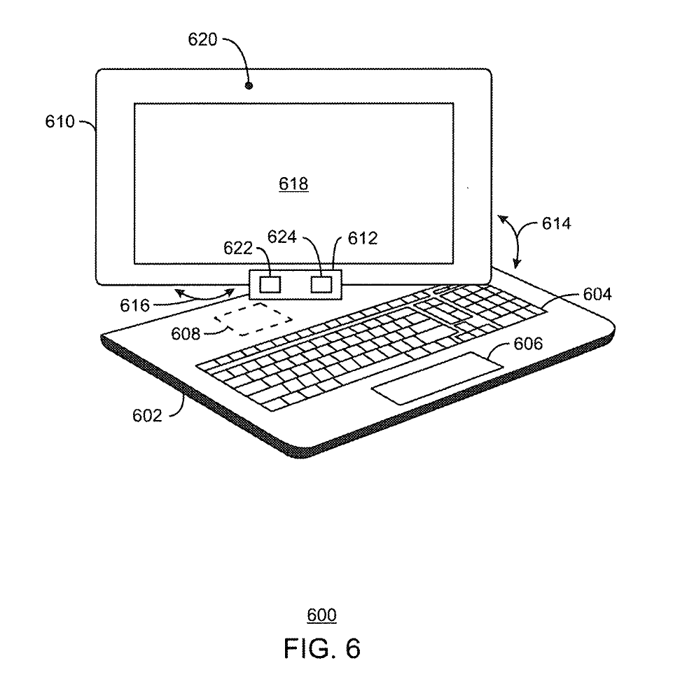

FIG. 6 is a perspective view of a convertible tablet 600 including both a pivot and a tilt in accordance with embodiments. In various embodiments, the convertible tablet 600 is the computing system 100 described above with respect to FIG. 1. Further, the convertible tablet 600 may be any type of computing device that includes both a pivot and tilt.

The convertible table 600 may include a base 602. The base 602 may include a keyboard 604 and a touchpad 606. The base 602 may also include an orientation sensor 608. The orientation sensor 608 may include a magnetometer, accelerometer, or a gyroscope, among others. In addition, the orientation sensor 608 may include a variety of different types of sensors. Further, the orientation sensor 608 may be located anywhere within the base 602 of the convertible tablet 600. In various embodiments, the orientation sensor 608 is used to detect an orientation of the base 602 relative to the environment of the computing device 600.

The convertible tablet 600 may also include a lid 610 that is attached to the base 602 via a connection 612. The connection 612 may allow the lid 610 to pivot with two degrees of freedom relative to the base 602. For example, the lid 610 can tilt as indicated by the arrow 614 and rotate as indicated by the arrow 616. The lid 610 may include a display screen 618 and a camera 620, such as a Webcam.

In addition, the lid 610 may include two alignment sensors 622 and 624. In the embodiment shown in FIG. 6, the alignment sensors 622 and 624 are included within the connection 612. However, the alignment sensors 622 and 624 may be located anywhere within the convertible tablet 600.

The first alignment sensor 622 may be a lid-rotation sensor that is used to detect the rotation of the lid 610. The second alignment sensor 624 may be a lid-tilt sensor that is used to detect the tilt of the lid 610. Together, the first alignment sensor 622 and the second alignment sensor 624 can be used to indicate an overall alignment of the lid 610 relative to the base 602. The alignment information that is obtained from the first alignment sensor 622 and the second alignment sensor 624 may be used in conjunction with the orientation information obtained from the orientation sensor 608 to determine an orientation of the lid 610 of the computing device 600 relative to the environment of the computing device 600. Further, in some embodiments, one or both of the alignment sensors 622 and 624 may be an orientation sensor that is used to detect an orientation of the lid 610 relative to the environment.

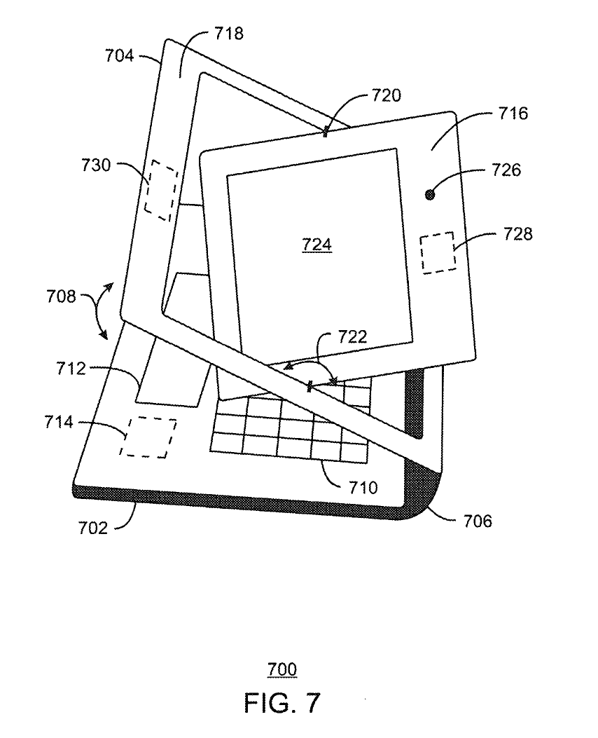

FIG. 7 is a perspective view of a convertible tablet 700 including two pivots in accordance with embodiments. In various embodiments, the convertible tablet 700 is the computing system 100 described above with respect to FIG. 1. The convertible tablet 700 may also be any type of computing device including a member that is capable of pivoting around at least two different axes.

The convertible table 700 may include a include a base 702, as well as lid 704 that is pivotally attached to the base 702. The lid 704 may be pivotally attached to the base 702 via a pivot connection 706. The pivot connection 706 may allow the lid 704 to pivot with respect to the base 702, as indicated by arrow 708.

The base 702 may include a keyboard 710 and a touchpad 712. The base 702 may also include an orientation sensor 714. The orientation sensor 714 may include a magnetometer or a gyroscope, among others. In various embodiment, the orientation sensor 714 is used to determine an orientation of the base 702 of the computing device 700. In addition, the orientation sensor 714 may include a variety of different types of sensors. Further, the orientation sensor 714 may be located anywhere within the base 702 of the convertible tablet 700.

The lid 704 may include an inner region 716 and an outer region 718. The inner region 716 and the outer region 718 may be pivotally attached via a pivot connection 720. The pivot connection 720 may allow the inner region 716 to rotate around the outer region 718, as indicated by arrow 722.

The inner region 716 may include a display screen 724 and a camera 726, such as a Webcam. In addition, the inner region 716 may include a first alignment sensor 728. The first alignment sensor 728 may be used to indicate an alignment of the inner region 716 of the lid 704 with respect to the outer region 718 of the lid 704. The first alignment sensor 728 may be located anywhere within the inner region 716 of the lid 704. In addition, the first alignment sensor 728 may be located within, or in proximity to, the pivot connection 720 that connects the inner region 716 to the outer region 718 of the lid 704.

Further, the outer region 718 of the lid 704 may include a second alignment sensor 730. The second alignment sensor 730 may be a lid-rotation sensor that is used to indicate an alignment of the base 702 and the lid 704 relative to each other. The second alignment sensor 730 may be located anywhere within the outer region 718 of the lid 704. In addition, the second alignment sensor 730 may be located within the pivot connection 706 that connects the lid 704 to the base 702.

In various embodiments, the orientation sensor 714, the first alignment sensor 728, and the second alignment sensor 730 are used to determine the orientation of the inner region 716 of the lid 704. For example, the orientation of the inner region 716 may be determined based on the orientation of the base 702 as determined by the orientation sensor 714, the alignment of the outer region 718 of the lid 704 with respect to the base 702 as determined by the second alignment sensor 730,and the alignment of the inner region 716 with respect to the outer region 718 as determined by the first alignment sensor 728.

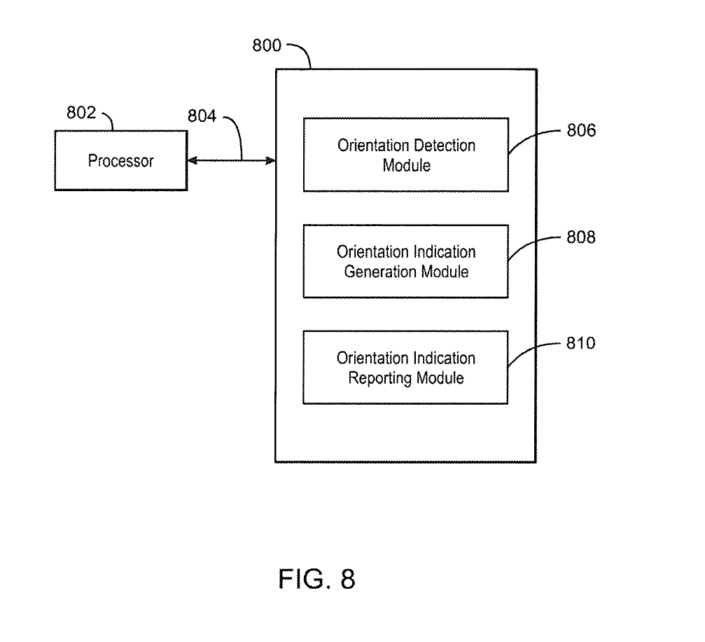

FIG. 8 is a block diagram showing a tangible, non-transitory computer-readable medium 800 that stores code for detecting the orientation of members of a computing device in accordance with embodiments. The tangible, non-transitory computer-readable medium 800 may be accessed by a processor 802 over a computer bus 804. Furthermore, the tangible, non-transitory, computer-readable medium 800 may include code configured to direct the processor 802 to perform the methods described herein.

The various software components discussed herein may be stored on the tangible, computer-readable medium 800, as indicated in FIG. 8. For example, an orientation detection module 806 may be configured to detect an orientation of a base of the computing device and an orientation of a lid of the computing device relative to an environment of the computing device using an orientation sensing system. In addition, the orientation detection module 806 may be configured to detect an alignment of the base and the lid of the computing device relative to each other. An orientation indicator generation module 808 may be configured to generate an orientation indicator based on the orientation of the base and the orientation of the lid. In addition, an orientation indicator reporting module 810 may be configured to send the orientation indicator to one or more applications executing on the computing device.

### EXAMPLE 1

A computing device is described herein. The computing device includes a base and a lid pivotally attached to the base. The computing device also includes an orientation sensing system configured to determine an orientation of the base and the lid relative to an environment of the computing device.

The orientation sensing system may include a first orientation sensor disposed in the base and a second orientation sensor disposed in the lid. Alternatively, the orientation sensing system may include a single orientation sensor and a lid alignment sensor that senses the alignment of the lid relative the base. The single orientation sensor may be disposed in the base, and the orientation of the lid may be computed by the orientation sensing system based on the orientation of the base and the alignment of the lid relative to the base. The single orientation sensor may also be disposed in the lid, and the orientation of the base may be computed by the orientation sensing system based on the orientation of the lid and the alignment of the lid relative to the base.

The orientation sensing system may generate an orientation indicator and send the orientation indicator to an application executing on the computing device. The orientation indicator may simultaneously indicate both the orientation of the base and the orientation of the lid. Alternatively, the orientation indicator may indicate a specified orientation including either the orientation of the base or the orientation of the lid. In addition, a user interface may enable a user to select the specified orientation as either the orientation of the base or the orientation of the lid.

### EXAMPLE 2

A method for determining the orientation of one or more members of a computing device is described herein. The method includes detecting an orientation of a lid of a computing device using a first orientation sensor located in the lid and detecting an orientation of a base of the computing device using a second orientation sensor located in the base. The method also includes generating an orientation indicator based on the orientation of the lid and the orientation of the base and sending the orientation indicator to an application executing on the computing device.

The orientation indicator may simultaneously indicate both the orientation of the base and the orientation of the lid. Alternatively, the orientation indicator may indicate a specified orientation including either the orientation of the base or the orientation of the lid. A user may be allowed to select the specified orientation as either the orientation of the base or the orientation of the lid via a user interface.

### EXAMPLE 3

Another method for determining the orientation of one or more members of a computing device is described herein. The method includes receiving an orientation signal from an orientation sensor disposed in a first member of a computing device, wherein the orientation signal indicates an orientation of the first member relative to an environment of the first member. The method also includes receiving an alignment signal from an alignment sensor that indicates an alignment of the first member relative to a second member of the computing device. The method includes computing an orientation of the second member based on the orientation signal and the alignment signal, wherein the computed orientation of the second member indicates the orientation of the second member relative to the environment of the second member. The method further includes generating an orientation indicator based, at least in part, on the orientation of the second member, and sending the orientation indicator to an application executing on the computing device.

The first member may be a base of the computing device, and the second member may be a lid of the computing device. Alternatively, the first member may be a lid of the computing device, and the second member may be a base of the computing device.

In addition, generating the orientation indicator based, at least in part, on the orientation of the second member may include generating the orientation indicator based on the orientation of the second member and the orientation of the first member.

### EXAMPLE 4

At least one machine readable medium having instructions stored therein is described herein. In response to being executed on a computing device, the instructions cause the computing device to detect an orientation of a base of the computing device and an orientation of a lid of the computing device relative to an environment of the computing device. The instructions also cause the computing device to generate an orientation indicator based on the orientation of the base and the orientation of the lid and send the orientation indicator to an application executing on the computing device. The number of instructions may include an orientation application programming interface (API).

Detecting the orientation of the base and the orientation of the lid relative to the environment may include collecting orientation information from one or more orientation sensors disposed within the computing device. In addition, detecting the orientation of the base and the orientation of the lid relative to the environment may include calculating an orientation of the computing device relative to a working surface.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions. claims

What is claimed is:

1. A computing device, comprising:
a base;
a lid pivotally attached to the base; and
an orientation sensing system configured to determine an orientation of the base and the lid relative to an environment of the computing device.

2. The computing device of claim 1, wherein the orientation sensing system comprises a first orientation sensor disposed in the base and a second orientation sensor disposed in the lid.

3. The computing device of claim 1, wherein the orientation sensing system comprises a single orientation sensor and a lid alignment sensor that senses the alignment of the lid relative to the base.

4. The computing device of claim 3, wherein the single orientation sensor is disposed in the base and the orientation of the lid is computed by the orientation sensing system based on the orientation of the base and the alignment of the lid relative to the base.

5. The computing device of claim 3, wherein the single orientation sensor is disposed in the lid and the orientation of the base is computed by the orientation sensing system based on the orientation of the lid and the alignment of the lid relative to the base.

6. The computing device of claim 1, wherein the orientation sensing system generates an orientation indicator and sends the orientation indicator to an application executing on the computing device.

7. The computing device of claim 6, wherein the orientation indicator simultaneously indicates both the orientation of the base and the orientation of the lid.

8. The computing device of claim 6, wherein the orientation indicator indicates a specified orientation comprising either the orientation of the base or the orientation of the lid.

9. The computing device of claim 8, comprising a user interface that enables a user to select the specified orientation as either the orientation of the base or the orientation of the lid.

10. A method, comprising:
detecting an orientation of a lid of a computing device using a first orientation sensor located in the lid;
detecting an orientation of a base of the computing device using a second orientation sensor located in the base; and
generating an orientation indicator based on the orientation of the lid and the orientation of the base; and
sending the orientation indicator to an application executing on the computing device.

11. The method of claim 10, wherein the orientation indicator simultaneously indicates both the orientation of the base and the orientation of the lid.

12. The method of claim 10, wherein the orientation indicator indicates a specified orientation comprising either the orientation of the base or the orientation of the lid.

13. The method of claim 12, comprising allowing a user to select the specified orientation as either the orientation of the base or the orientation of the lid via a user interface.

14. A method, comprising:
receiving an orientation signal from an orientation sensor disposed in a first member of a computing device, wherein the orientation signal indicates an orientation of the first member relative to an environment of the first member;
receiving an alignment signal from an alignment sensor that indicates an alignment of the first member relative to a second member of the computing device;
computing an orientation of the second member based on the orientation signal and the alignment signal, wherein the computed orientation of the second member indicates the orientation of the second member relative to the environment of the second member;
generating an orientation indicator based, at least in part, on the orientation of the second member; and
sending the orientation indicator to an application executing on the computing device.

15. The method of claim 14, wherein the first member is a base of the computing device and the second member is a lid of the computing device.

16. The method of claim 14, wherein generating the orientation indicator based, at least in part, on the orientation of the second member comprises generating the orientation indicator based on the orientation of the second member and the orientation of the first member.

17. At least one machine readable medium having instructions stored therein that, in response to being executed on a computing device, cause the computing device to:
detect an orientation of a base of the computing device and an orientation of a lid of the computing device relative to an environment of the computing device;
generate an orientation indicator based on the orientation of the base and the orientation of the lid; and
send the orientation indicator to an application executing on the computing device.

18. The at least one machine readable medium of claim 17, wherein the plurality of instructions comprise an orientation application programming interface (API).

19. The at least one machine readable medium of claim 17, wherein detecting the orientation of the base and the orientation of the lid relative to the environment comprises collecting orientation information from one or more orientation sensors disposed within the computing device.

20. The at least one machine readable medium of claim 17, wherein detecting the orientation of the base and the orientation of the lid relative to the environment comprises calculating an orientation of the computing device relative to a working surface.
